(19) United States
(12) Patent Application Publication
(10) Pub. No.: US 2026/0261179 A1
(43) Pub. Date: Sep. 3, 2026

(54) MECHANICAL-ELECTRICAL INTEGRATED ROTARY ELECTRIC MACHINE DEVICE

(71) Applicant: ASTEMO, LTD., Chiyoda-ku, Tokyo (JP)

(72) Inventor: Shuichi SHINOHARA, Hitachinaka-shi, Ibaraki (JP)

(73) Assignee: ASTEMO, LTD., Chiyoda-ku, Tokyo (JP)

(21) Appl. No.: 19/164,608

(22) PCT Filed: Jun. 29, 2023
(86) PCT No.: PCT/JP2023/024267

§ 371 Date: Sep. 12, 2025

(51) Int. Cl. H02K 5/22; H02K 11/33

(52) U.S. Cl. CPC H02K 5/225; H02K 11/33; H02K 2203/09

(57) ABSTRACT

A mechanical-electrical integrated rotary electric machine device includes: a rotary electric machine; a power conversion device; a housing that houses the rotary electric machine and the power conversion device; a busbar module that electrically connects a plurality of first connecting parts of the power conversion device to a plurality of second connecting parts of the rotary electric machine; an opening formed on a wall of the housing, the opening being counter to the plurality of second connecting parts; and a cover that covers the opening. The busbar module includes: a plurality of busbars each having a first busbar connecting part connected to the first connecting part, an extending part extending from the first busbar connecting part to the second connecting part, and a second busbar connecting part bent from the extending part and connected to the second connecting part; and a busbar holder with electrical insulation that covers the extending parts of the plurality of busbars arranged in such a way as to separate the second busbar connecting parts from each other. The cover includes: an opening closing part that closes the opening; and a partition wall with electrical insulation that projects from the opening closing part toward the plurality of second connecting parts to which the second busbar connecting parts are connected and that is inserted between the second busbar connecting parts.

### TECHNICAL FIELD

The present invention relates to a mechanical-electrical integrated rotary electric machine device.

### BACKGROUND ART

A mechanical-electrical integrated rotary electric machine device configured to house a motor, which is a rotary electric machine, and an inverter, which is a power conversion device, integrally in a housing has been known for years. A plurality of busbars connecting the motor and the inverter are overmolded with an insulating resin or the like to ensure insulation against surrounding members and interphase insulation.

PTL 1 describes a configuration in which such overmolding is not used. According to a technique described in PTL 1, a busbar connected to a terminal extending out from a power module is placed on a tray provided with an insulating sheet. A connection hole is formed on the other end of the busbar extending linearly, and a terminal member on the motor side is inserted into the hole from below for connection.

### Citation List

### Patent Literature

PTL 1: JP 6409968 B2

### SUMMARY OF INVENTION

### Technical Problem

The technique described in PTL 1 provides a configuration in which the busbar is placed on the tray horizontal to a motor housing unit and a motor-side connecting part is extended to the position of the busbar. It is therefore necessary that the motor-side connecting part can be extended to the position of the tray.

However, placement of the power module that needs a cooling mechanism depends on a configuration on the power conversion device side, and a connection terminal of the power module cannot always be placed near the motor-side connecting part. Such a case requires that the busbar be extended from the connection terminal of the power module to a region where the motor-side connecting part is located and that a busbar connecting part be bent and brought closer to the motor-side connecting part. Thus, in the configuration in which overmolding is not used, ensuring the insulation properties of a busbar extending region and a motor connection region is a problem to address.

### Solution to Problem

A mechanical-electrical integrated rotary electric machine device according to an aspect of the present invention includes: a rotary electric machine; a power conversion device connected to the rotary electric machine; a housing that houses the rotary electric machine and the power conversion device; a busbar module that electrically connects a plurality of first connecting parts of the power conversion device to a plurality of second connecting parts of the rotary electric machine; an opening formed on a wall of the housing, the opening being counter to the plurality of second connecting parts; and a cover that covers the opening. The busbar module includes: a plurality of busbars each having a first busbar connecting part connected to the first connecting part, an extending part extending from the first busbar connecting part to the second connecting part, and a second busbar connecting part bent from the extending part and connected to the second connecting part; and a busbar holder with electrical insulation that covers the extending parts of the plurality of busbars arranged in such a way as to separate the second busbar connecting parts from each other. The cover includes: an opening closing part that closes the opening; and a partition wall with electrical insulation that projects from the opening closing part toward the plurality of second connecting parts to which the second busbar connecting parts are connected and that is inserted between the second busbar connecting parts adjacent to each other.

### Advantageous Effects of Invention

According to the present invention, in the configuration in which overmolding is not used, the insulation properties of the busbar extending region and the motor connection region can be ensured.

### BRIEF DESCRIPTION OF DRAWINGS

FIG. 1 is a perspective view of an external appearance of a mechanical-electrical integrated rotary electric machine device according to the present invention.

FIG. 2 depicts a schematic configuration of a power conversion device.

FIG. 3 depicts a part of component layout in an inverter housing.

FIG. 4 is a perspective view of an external appearance of a busbar module.

FIG. 5 is another perspective view of the external appearance of the busbar module.

FIG. 6 depicts a shape of busbars for three phases.

FIG. 7 depicts a surface of one holder member, the surface being on a busbar side.

FIG. 8 depicts a surface of the other holder member, the surface being on the busbar side.

FIG. 9 depicts an Al-Al cross section of FIG. 5.

FIG. 10 is an explanatory view of a snap-fit mechanism.

FIG. 11 is an enlarged view of an inverter housing region in which second busbar connecting parts are placed.

FIG. 12 is a perspective view of an external appearance of a terminal cover.

### DESCRIPTION OF EMBODIMENTS

Embodiments for carrying out the present invention will hereinafter be described with reference to the accompanying drawings. The following description and drawings are examples for describing the present invention, and are omitted or simplified when necessary to make the description clear. In the following description, the same or similar elements and processes are denoted by the same reference signs, and redundant description may be omitted. It should be noted that what is described below is merely an example of an embodiment of the present invention and that the present invention is not limited to the following embodiment and can be implemented in other various forms.

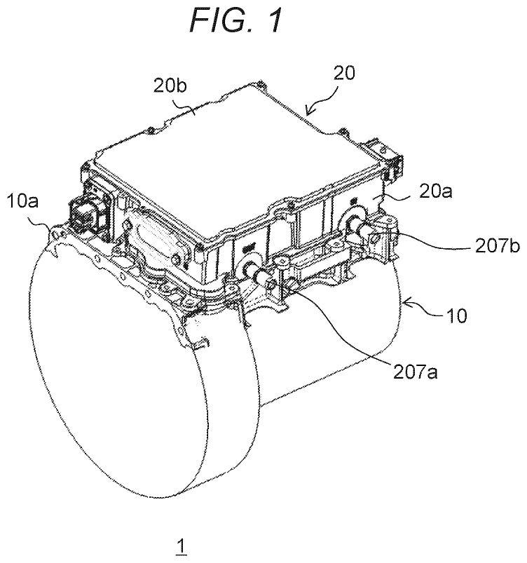

FIG. 1 is a perspective view of an external appearance of a mechanical-electrical integrated rotary electric machine device 1 according to the present invention. The mechanical-electrical integrated rotary electric machine device 1 is constructed by configuring a rotary electric machine 10 and a power conversion device 20 into an integral structure. The 1 is used, for example, as a traveling drive unit of an electric vehicle. The rotary electric machine 10, such as a motor, has a housing 10a of a substantially cylindrical shape (which will hereinafter be referred to as a motor housing) that houses a rotor and a stator. A part under a part denoted by reference sign 10a is shown as a large cylinder and a small cylinder because depiction of their detailed shapes is omitted. On the top of the motor housing 10a in FIG. 1, a housing 20a of a substantially rectangular parallelepiped (which will hereinafter be referred to as an inverter housing), the housing 20a containing electrical components making up the power conversion device 20, is fixed with bolts or the like. The inverter housing 20a is provided with an upper cover 20b that covers the top of the inverter housing 20a.

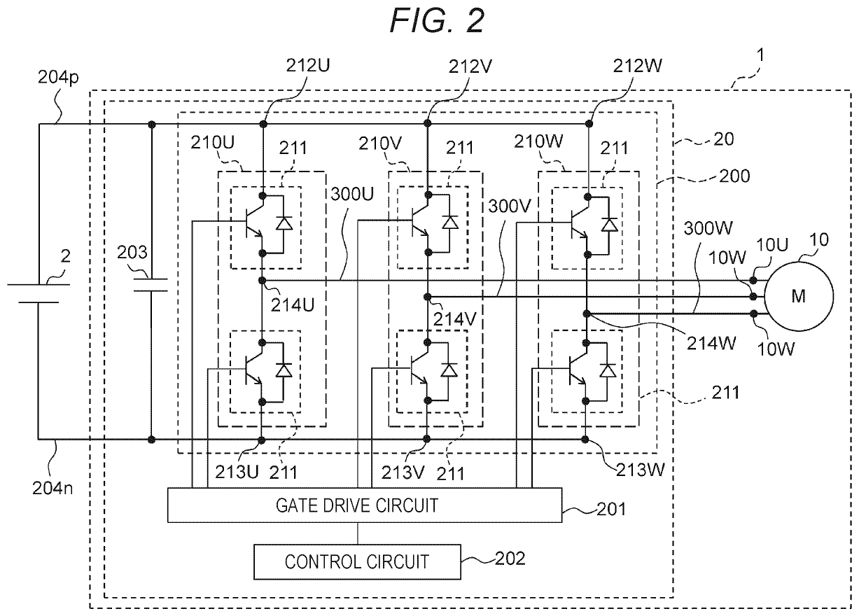

FIG. 2 depicts a schematic configuration of the power conversion device 20. The power conversion device 20 converts DC power supplied from a DC power supply 2 into AC power, thereby driving the rotary electric machine 10. The power conversion device 20 includes a power conversion circuit 200, a gate drive circuit 201, a control circuit 202, and a smoothing capacitor 203. The power conversion circuit 200 includes power modules 210U, 210V, and 210W of U-phase, V-phase, and W-phase.

The power modules 210U, 210V, and 210W each include a set of two power semiconductors 211 making up an upper arm and a lower arm respectively. The power modules 210U, 210V, and 210W each include three terminals (the power modules 210U, 210V, and 210W thus include connection P terminals 212U, 212V, and 212W, connection N terminals 213U, 213V, and 213W, and connection AC terminals 214U, 214V, and 214W). The connection P terminals 212U, 212V, and 212W are connected to a positive electrode bus line 204p, and the connection N terminals 213U, 213V, and 213W are connected to a negative electrode bus line 204n. The connection AC terminals 214U, 214V, and 214W are connected to motor-side connecting parts 10U, 10V, and 10W connected to windings of the corresponding phases of the rotary electric machine 10, via busbars 300U, 300V, and 300W, which will be described later.

Each power semiconductor 211 switches on/off according to a drive signal inputted from the gate drive circuit 201, thus converting DC power into AC power. The control circuit 202 inputs on/off instructions for each power semiconductor 211 into the gate drive circuit 201, based on an instruction from a host controller (not illustrated) provided on a vehicle side.

As the power semiconductor 211, for example, a power metal oxide semiconductor field effect transistor (power MOSFET), an insulated gate bipolar transistor (IGBT), or the like is used. In the example shown in FIG. 2, an IGBT is used as the power semiconductor 211.

Both ends of the smoothing capacitor 203 are connected to the positive electrode bus line 204p and the negative electrode bus line 204n, respectively. The smoothing capacitor 203 is a capacitor that smooths a current generated by switching on/off of the power semiconductor 211 and that suppresses ripples of a DC current supplied from the DC power supply 2 to the power conversion circuit 200. As the smoothing capacitor 203, for example, an electrolytic capacitor or a film capacitor is used.

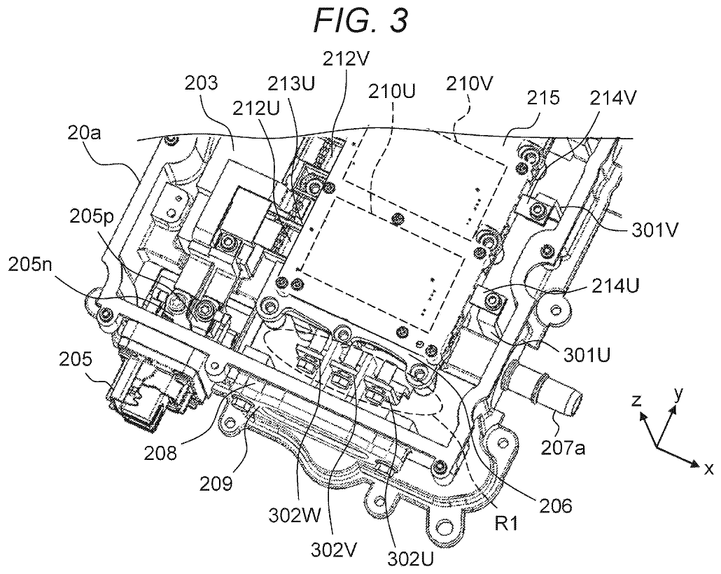

FIG. 3 depicts a part of component layout in the inverter housing 20a. FIG. 3 shows a part of the power conversion device 20 in its state where the upper cover 20b covering the top of the inverter housing 20a is removed. Under a circuit board 215 carrying the gate drive circuit 201 and the like, a module housing unit 206 housing the power modules 210U to 210W is disposed. Although the power module 210W is not shown in FIG. 3, it is placed on the upper side relative to the power module 210V in FIG. 3. A refrigerant channel (not illustrated) is formed in the module housing unit 206, where the power modules 210U to 210W are arranged on the refrigerant channel. The power modules 210U to 210W are cooled by a refrigerant flowing through the refrigerant channel. A side wall of the inverter housing 20a is provided with a supply port 207a that supplies the refrigerant and with a discharge port 207b (see FIG. 1) that discharges the refrigerant.

The inverter housing 20a is provided with a DC connector 205 connected to the DC power supply 2 located outside the inverter housing 20a. The positive electrode bus line 204p is connected to a positive electrode terminal 205p of the DC connector 205, and the negative electrode bus line 204n is connected to a negative electrode terminal 205n. As described above, the connection P terminals 212U to 212W of the power modules 210U to 210W are connected to the positive electrode bus line 204p, and the connection N terminals 213U, 213V, and 213W are connected to the negative electrode bus line 204n.

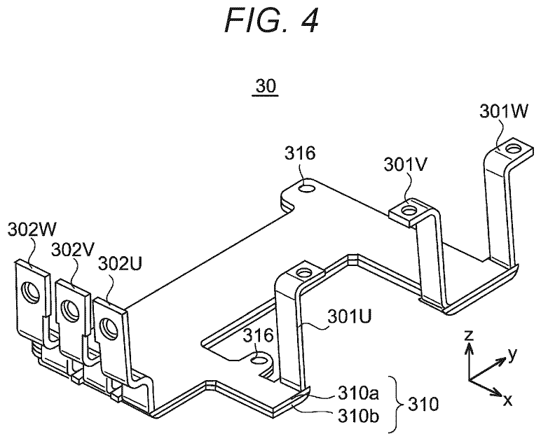

Under the module housing unit 206 in FIG. 3, a busbar module 30 (see FIG. 4), which will be described later, is disposed. The busbar module 30, which will be described in detail later, includes busbars 300U, 300V, and 300W, and a busbar holder 310. The busbars 300U, 300V, and 300W include first busbar connecting parts 301U, 301V, and 301W connected to the connection AC terminals 214U, 214V, and 214W of the power modules 210U to 210W, and second busbar connecting parts 302U, 302V, and 302W connected to the motor-side connecting parts 10U, 10V, and 10W of U phase, V phase, and W phase on the rotary electric machine 10 side, respectively. In FIG. 3, the first busbar connecting parts 301U and 301V, and the second busbar connecting parts 302U, 302V, and 302W are shown.

Although not illustrated, in a region R1 in the inverter housing 20a, the motor-side connecting parts 10U, 10V, and 10W extend out of the motor housing 10a. Therefore, the second busbar connecting parts 302U, 302V, and 302W of the busbars 300U, 300V, and 300W are also placed in the region R1. On a side wall of the inverter housing 20a, an opening 208 is formed in a side wall region counter to the second busbar connecting parts 302U, 302V, and 302W. A terminal cover 209 is fixed to the opening 208 with bolts or the like. As a result, an opening region 208 is covered with the terminal cover 209.

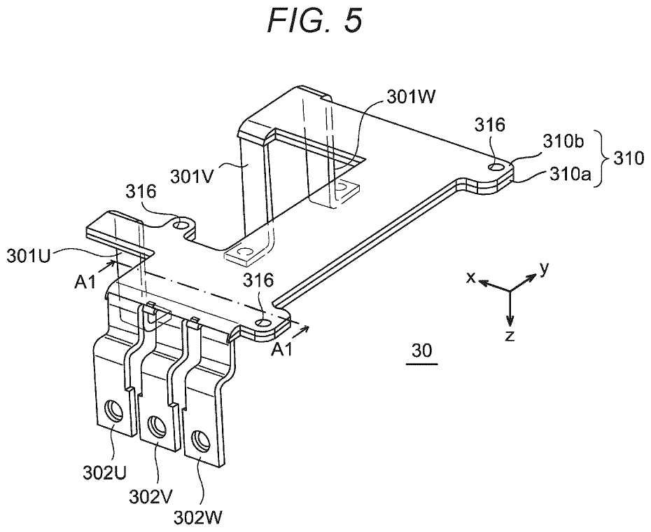

FIGS. 4 and 5 are perspective views of an external appearance of the busbar module 30. FIG. 4 shows the busbar module 30 placed in the same manner as it is placed in FIG. 3 (a z-axis points to the upper side in FIG. 4). FIG. 5, on the other hand, shows a case where coordinate axes are set in such a way as to point the z-axis toward the lower side, that is, FIG. 5 shows a perspective view of the busbar module 30 in a case where it is seen from the bottom side of the inverter housing 20a. The busbar module 30 includes three busbars 300U, 300V, and 300W corresponding respectively to the U phase, the V phase, and the W phase, and the busbar holder 310. The busbar module 30 is fixed to a lower part (back surface side) of the module housing unit 206 shown in FIG. 3 with bolts or the like, using a plurality of fixing holes 316 formed on the busbar holder 310.

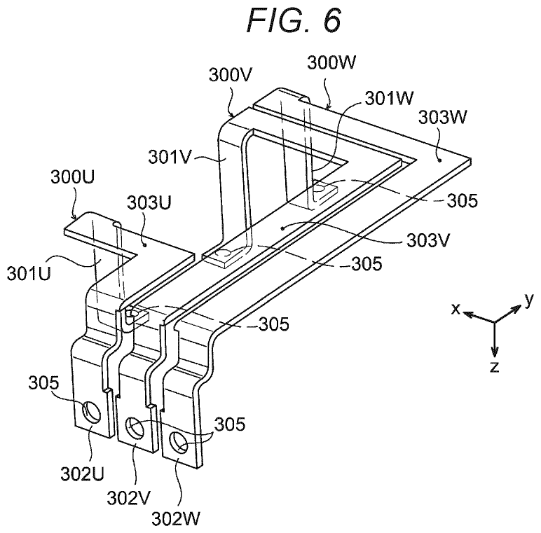

FIG. 6 depicts a shape of the busbars 300U, 300V, and 300W included in the busbar module 30. The busbars 300U, 300V, and 300 W arranged in the same manner as in the busbar module 30 are shown. The busbars 300U, 300V, and 300W are each formed of an elongated, plate-like conductive member (e.g., a metal member having excellent conductivity, such as oxygen-free copper).

The busbar 300U has an extending part 303U extended into an L shape on an xy plane, and a first busbar connecting part 301U and a second busbar connecting part 302U that are formed on both ends of the busbar 300U and that are bent in a z-axis positive direction from the extending part 303U, respectively. Similarly, the busbars 300V and 300W have extending parts 303V and 303W of L shapes on the xy plane, and first busbar connecting parts 301V and 301W and second busbar connecting parts 302V and 302W that are bent in the z-axis positive direction from the extending parts 303V and 303W, respectively. A fastening hole 305 used for busbar connection is formed on each of the busbar connecting parts 301U to 301W and the busbar connecting parts 302U to 302W.

The busbar holder 310 is formed of an electrically insulating member that covers the extending parts 303U to 303W of the busbars 300U to 300W. As the insulating member, a resin, ceramics, or the like is used. As shown in FIGS. 4 and 5, the busbar holder 310 is composed of a holder member 310a that covers a z direction positive side of the extending parts 303U to 303W, and a holder member 310b that covers a z direction negative side of the extending parts 303U to 303W. The busbar connecting parts 301U to 301W and 302U to 302W of the busbars 300U to 300W are exposed from the busbar holder 310.

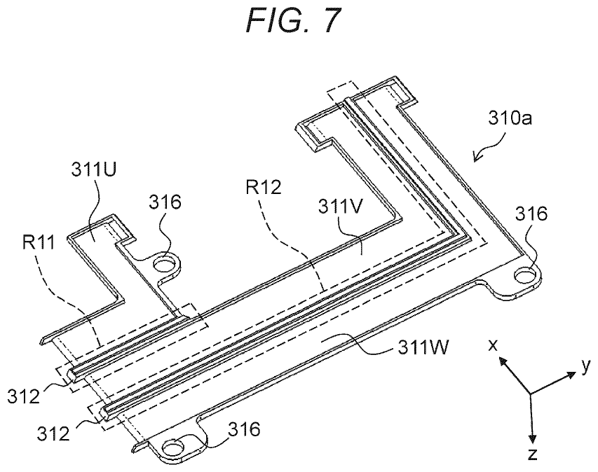

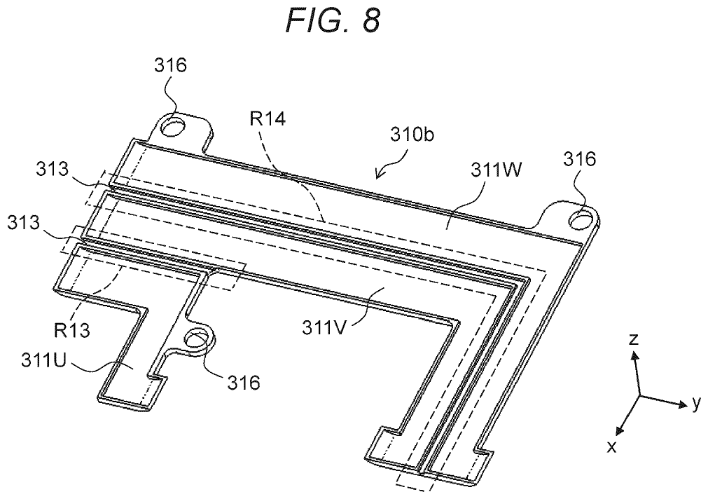

FIG. 7 depicts a surface of the holder member 310a, the surface being on a busbar side. FIG. 8 depicts a surface of the holder member 310b, the surface being on the busbar side. The holder members 310a and 310b each include a groove 311U in which the extending part 303U is placed, a groove 311V in which the extending part 303V is placed, and a groove 311W in which the extending part 303W is placed. Partitions 312 are formed in a region R11 between the groove 311U and the groove 311V of the holder member 310a and a region R12 between the groove 311V and the groove 311W, respectively. Similarly, partitions 313 are formed in a region R13 between the groove 311U and the groove 311V of the holder member 310b and a region R14 between the groove 311V and the groove 311W, respectively.

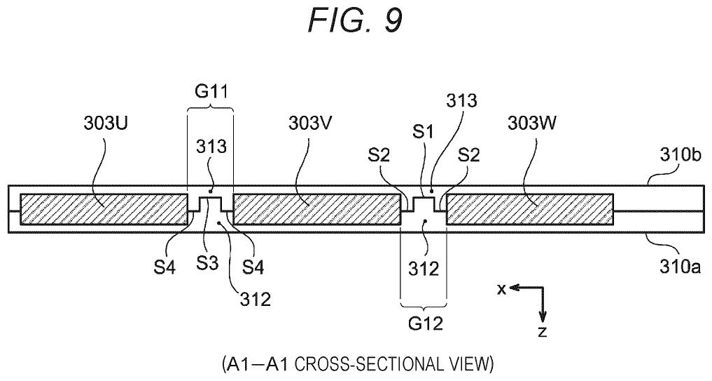

FIG. 9 depicts an A1-A1 cross section of FIG. 5. A configuration of the partitions 312 and 313 will be described with reference to FIG. 9. The partitions 312 formed on the holder member 310a and the partitions 313 formed on the holder member 310b are counter to each other. A pair of partitions 312 and 313 counter to each other on the left side in FIG. 9 are provided in such a way as to fill a gap G11 between the extending part 303U and the extending part 303V. Similarly, a pair of partitions 312 and 313 counter to each other on the right side in FIG. 9 are provided in such a way as to fill a gap G12 between the extending part 303V and the extending part 303W.

A surface of partition 312 that is counter to the partition 313 is provided with a convex part S1 located at the center and with concave parts S2 located on both sides of the convex part S1. A surface of partition 313 that is counter to the partition 312, on the other hand, is provided with a concave part S3 located at the center and with convex parts S4 located on both sides of the concave part S3. The convex part S1 of the partition 312 is fitted into the concave part S3 of the partition 313, and the convex parts S4 of the partition 313 are fitted into the concave parts S2 of the partition 312.

As shown in FIG. 9, because the gaps G11 and G12 between the busbars are filled with the partitions 312 and 313 that are insulating members, interphase insulation performance can be ensured. In addition, because a contact surface between the partition 312 and the partition 313 is of an uneven shape, a creepage distance increases, which allows an improvement in interphase insulation.

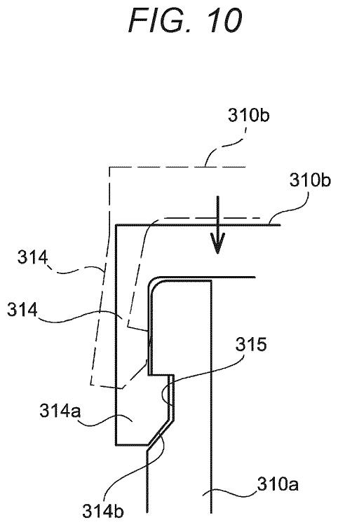

To couple the holder members 310a and 310b together, for example, a mechanical coupling method called snap-fit, as shown in FIG. 10, is used. The holder member 310b has a coupling claw 314 with a protrusion 314a formed thereon, and the holder member 210a has a recess 315 with which the protrusion 314a is engaged. When the holder member 310b is brought closer to the holder member 310a, as indicated by an arrow, a sloped part 314b on a front end of the coupling claw 314 comes in contact with an upper end of the holder member 310a, which causes the coupling claw 314 to deform elastically, as indicated by a broken line. Further moving the holder member 310b downward causes the protrusion 314a of the coupling claw 314 to fit into the recess 315 of the holder member 310a and engage with the recess 315. As a result, the holder members 310a and 310b are coupled together.

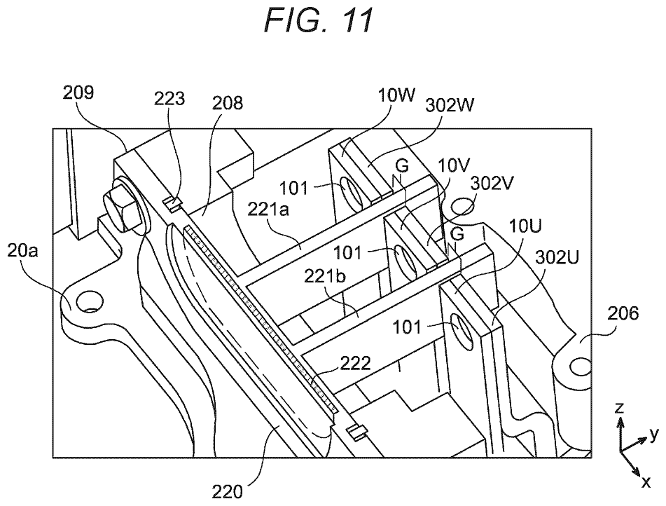

FIG. 11 is an enlarged view of a part where the opening 208 provided with the terminal cover 209 of FIG. 3 and the second busbar connecting parts 302U to 302W of the busbars 300U to 300W are arranged. FIG. 11 shows the motor-side connecting parts 10U, 10V, and 10W as well. The opening 208 formed on the side wall of the inverter housing 20a is an opening for performing work of connecting the second busbar connecting parts 302U to 302W of the busbars 300U to 300W and the motor-side connecting parts 10U, 10V, and 10W to each other. A tool or the like is inserted into the inverter housing 20a through the opening 208, and the connecting parts are screw-fastened together.

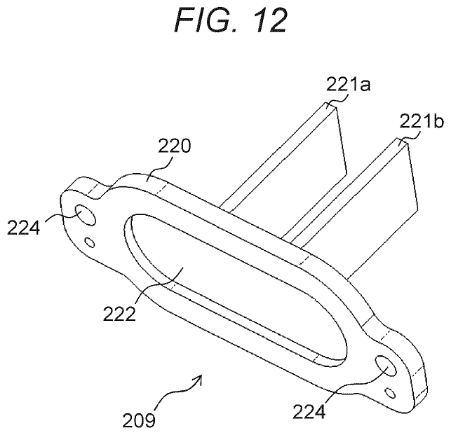

FIG. 12 is a perspective view of an external appearance of the terminal cover 209. The terminal cover 209 includes a closing part 220 that covers the opening 208 formed on the side wall of the inverter housing 20a, and insulating walls 221a and 221b of plate shapes erected on the inner peripheral surface of the closing part 220. The closing part 220 has holes 224 for bolting the terminal cover 209 to the inverter housing 20a. The terminal cover 209 is made of an electrically insulating material (e.g., a resin material).

FIG. 11 shows a cross section of the terminal cover 209 attached to the opening 208. A gap between the closing part 220 of the terminal cover 209 and the side wall of the inverter housing 20a is sealed by a sealing material 223. A metal plate 222 is embedded in the closing part 220 of the terminal cover 209.

In the inverter housing 20a, the motor connecting parts 10U to 10W are led out from the motor housing 10a such that the motor connecting parts 10U to 10W are counter to the opening 208. The second busbar connecting parts 302U to 302W of the busbars 300U to 300W are bent in such a way as to come closer to the motor connecting parts 10U to 10W, that is, bent along the z-axis direction from the extending parts 303U to 303W. The second busbar connecting parts 302U to 302W are arranged such that they overlap the motor connection parts 10U to 10W of the corresponding phases, respectively, in a y direction. Work of screw-fastening these second busbar connecting parts and motor connection parts together is carried out, as mentioned above, through the opening 208.

For example, although not illustrated, nuts are fixed in advance to surfaces of the second busbar connecting parts 302U to 302W, the surfaces being on the positive side in the y direction, by welding or the like, and bolts are inserted into connection holes 101 of the motor connecting parts 10U to 10W and are fastened to the nuts. In the example shown in FIG. 11, the motor connecting parts 10U to 10W and the second busbar connecting parts 302U to 302W are placed side by side in this order in the y direction. However, they may be placed side by side in the reverse order. In the latter case, the nuts are fixed to the motor connecting parts 10U to 10W.

A gap G is formed between a set of the motor connecting part 10U and the second busbar connecting part 302U and a set of the motor connecting part 10V and the second connecting part 302V, and another gap G is formed between a set of the motor connecting part 10V and the second busbar connecting part 302V and a set of the motor connecting part 10W and the second busbar connecting part 302W. The insulating walls 221a and 221b of the terminal cover 209 fixed to the opening 208 are inserted into the gaps G, respectively. By inserting the insulating walls 221a and 221b into the gaps G, the interphase insulation performance of the connecting parts, where conductors are exposed, can be maintained. In addition, because the metal plate 222 is embedded in the closing part 220 covering the opening 208, radiation noise generated by an AC current is blocked by the metal plate 222. This suppresses radiation noise leaking out of the inverter housing 20a.

When the work of screw-fastening together the motor connecting parts 10U to 10W and the second busbar connecting parts 302U to 302W is over, the terminal cover 209 is attached to the opening 208 and is bolted down thereto. When the terminal cover 209 is attached to the opening 208, the insulating walls 221a and 221b projecting from the opening 208 into the housing are first inserted into the gaps G, respectively. Then, as the insulating walls 221a and 221b are guided by the gaps G, the closing part 220 is placed at a given position of the opening 208 and then is fixed with bolts. In this manner, the insulating walls 221a and 221b function also as a guide that provides guide when the terminal cover 209 is attached to the opening portion 208. Hence workability at the time of attachment of the terminal cover 209 can be improved.

The above-described embodiment of the present invention offers the following advantageous effects.
(1) As shown in FIGS. 2 to 6, the mechanical-electrical integrated rotary electric machine device 1 includes: the rotary electric machine 10; the power conversion device 20 connected to the rotary electric machine 10; the inverter housing (housing) 20a that houses the rotary electric machine 10 and the power conversion device 20; the busbar module 30 that electrically connects the plurality of connection AC terminals (first connecting parts) 214U to 214W of the power conversion device 20 to the plurality of motor-side connecting parts (second connecting parts) 10U to 10W of the rotary electric machine 10; the opening 208 formed on the wall of the inverter housing 20a, the opening 208 being counter to the plurality of motor-side connecting parts 10U to 10W; and the terminal cover (cover) 209 that covers the opening 208. The busbar module 30 includes: the plurality of busbars 300U to 300W which have the first busbar connecting parts 301U to 301W connected to the connection AC terminals 214U to 214W, extending parts 303U to 303W extending from the first busbar connecting parts 301U to 301W to the motor-side connecting parts 10U to 10W, and the second busbar connecting parts 302U to 302W bent from the extending parts 303U to 303W and connected to the motor-side connecting parts 10U to 10W, respectively; and the busbar holder 310 with electrical insulation that covers the extending parts 303U to 303W of the plurality of busbars 300U to 300W arranged such that the second busbar connecting parts 302U to 302W are separated from each other. The terminal cover 209 includes: the closing part (opening closing part) 220 that closes the opening 208; and the insulating walls (partition walls) 221a and 221b with electrical insulation that project from the closing part 220 toward the plurality of motor-side connecting parts 10U to 10W, to which the second busbar connecting parts 302U to 302W are connected, and that are each inserted between second busbar connecting parts adjacent to each other, the second busbar connecting parts being among the second busbar connecting parts 302U to 302W.

As described above, because the insulating walls 221a and 221b of the terminal cover 209 are inserted between the second busbar connecting parts 302U to 302W, the interphase insulation of the second busbar connecting parts 302U to 302W, which are bent and exposed, can be ensured. As a result, the busbar holder 310 can be configured to cover the extending parts 303U to 303W, which do not include the second busbar connecting parts 302U to 302W. Hence the shape of an insulating mold can be simplified, regardless of the shape of the second busbar connecting parts 302U to 302W, and a molding material can be reduced as well. In this manner, by the busbar holder 310 and the terminal cover 209, the insulation properties of the extending parts 303U to 303W, which constitute an extending region where the busbars 300U to 300W are extended, and of the second busbar connecting parts 302U to 302W, which constitute a motor connection region, can be ensured.

Furthermore, because the insulating walls 221a and 221b function as the guide when the terminal cover 209 is attached to the opening 208, workability at the time of attachment of the terminal cover 209 to the opening 208 can be improved.
(2) In (1) described above, it is preferable that, as shown in FIGS. 4 to 6 and the like, the busbar holder 310 integrally cover the plurality of extending parts 303U to 303W arranged to be separated from each other. For example, in a case where the mechanical-electrical integrated rotary electric machine device 1 is incorporated in a vehicle, if the busbar holder 310 is not provided, the vibration of the vehicle causes the extending parts 303U to 303W to vibrate, in which case the busbars shift easily. However, by integrally covering the plurality of extending parts 303U to 303W with the busbar holder 310, the vibration of the extending parts 303U to 303W is curbed.
(3) In (2) described above, as shown in FIGS. 5 to 9 and the like, the plurality of busbars 300U to 300W are formed of plate-shaped conductors, and the plurality of extending parts 303U to 303W are placed side by side in the direction perpendicular to the direction of penetrating the plate-shaped conductors from their front surfaces to back surfaces, with the gaps G11 and G12 formed respectively between adjacent pairs of extending parts. The busbar holder 310 includes the holder member (first holder member) 310a with electrical insulation that covers the front surface side of the plurality of extending parts 303U to 303W, and the holder member (second holder member) 310b with electrical insulation that covers the back surface side of the plurality of extending parts 303U to 303W.

In this manner, a configuration in which two holder members 310a and 310b sandwich the extending parts 303U to 303W allows simplification of the shape of the busbar holder 310. In addition, the sandwiching structure allows use of the snap-fit coupling mechanism shown in FIG. 10, thus allowing simplification of the coupling mechanism.
(4) In (3) described above, as shown in FIG. 9 and the like, the partition (first partition) 312 the holder member (first holder member) 310a has and the partition (second partition) 313 the holder member (second holder member) 310b has are arranged in each of the gaps G11 and G12. The counter surface of the partition 312 and the counter surface of the partition 313 have the convex part S1 and the convex parts S4, respectively, and have the concave parts S2 and the concave part S3, respectively. The convex part S1 of the partition 312 is fitted into the concave part S3 of the partition 313, and the convex parts S4 of the partition 313 are fitted into the concave parts S2 of the partition 312. In this manner, by forming the convex parts S1 and S4 on the counter surfaces of the partitions 312 and 313, respectively, and forming the concave parts S2 and S3 on the same, respectively, the convex parts S1 and S4 and the concave parts S2 and S3 being fitted together, the interphase creepage distance is increased. As a result, the interphase insulation performance can be improved.
(5) In (1) described above, as shown in FIGS. 11 and 12 and the like, the terminal cover 209 may be made of an electrically insulating material. In this manner, by making the entire terminal cover 209 including the insulating walls 221a and 221b out of the electrically insulating material, processing cost can be reduced.
(6) In (5) described above, as shown in FIG. 11, the metal plate 222 is embedded in the closing part (opening closing part) 220 of the terminal cover 209. In this manner, by embedding the metal plate 222 in the closing part 220 covering the opening 208, radiation noise generated by an AC current is blocked by the metal plate 222, and therefore radiation noise leaking out of the inverter housing 20a can be suppressed.
(7) In (3) described above, as shown in FIGS. 6 and 11, the second busbar connecting parts 302U to 302W are bent from the extending parts 303U to 303W such that one of the front and back surfaces of each of the second busbar connecting parts 302U to 302W is counter to the opening 208, and the motor-side connecting parts (second connecting parts) 10U to 10W are arranged in such a way as to be each counter to one of the front and back surfaces of each of the second busbar connecting parts 302U to 302W in one-to-one correspondence. In this manner, the motor-side connecting parts 10U to 10W and the second busbar connecting parts 302U to 302W that are arranged in such a way as to overlap each other are set counter to the opening 208. Because of this, fastening work through the opening 208 can be carried out easily.

The second busbar connecting parts 302U to 302W bent from the extending parts 303U to 303W are exposed from the busbar holder 310, as shown in FIG. 5. The interphase insulation of the second busbar connecting parts 302U to 302W is, however, ensured by inserting each of the insulating walls 221a and 221b of the terminal cover 209 between second busbar connecting parts adjacent to each other, the second busbar connecting parts being among the second busbar connecting parts 302U to 302 W.

The embodiments and various modifications described above are merely examples, and the present invention is not limited to the contents of these embodiments and modifications under the condition that the features of the invention are not impaired. While various embodiments and modifications have been described above, the present invention is not limited to the contents of these embodiments and modifications. Other modes that are conceivable within the range of the technical idea of the present invention are also included in the scope of the present invention.

### Reference Signs List

1 mechanical-electrical integrated rotary electric machine device
10 rotary electric machine
10U, 10V, 10W motor-side connecting part
20 power conversion device
10a motor housing
20a inverter housing 30 busbar module
204n negative electrode bus line
204p positive electrode bus line
206 module housing unit
208 opening
209 terminal cover
210U, 210V, 210W power module
212U, 212V, 212W connection P terminal
213U, 213V, 213W connection N terminal
214U, 214V, 214W connection AC terminal
221a, 221b insulating wall
220 closing part
222 metal plate
300U, 300V, 300W busbar
301U, 301V, 301W first busbar connecting part
302U, 302V, 302W second busbar connecting part
303U, 303V, 303W extending part
310 busbar holder
310a, 310b holder member
311U, 311V, 311W groove
312, 313 partition
G, G11, G12 gap
S1, S4 convex part
S2, S3 concave part

1. A mechanical-electrical integrated rotary electric machine device comprising:
a rotary electric machine;
a power conversion device connected to the rotary electric machine; a housing that houses the rotary electric machine and the power conversion device;
a busbar module that electrically connects a plurality of first connecting parts of the power conversion device to a plurality of second connecting parts of the rotary electric machine;
an opening formed on a wall of the housing, the opening being counter to the plurality of second connecting parts; and
a cover that covers the opening, wherein
the busbar module includes:
a plurality of busbars each having a first busbar connecting part connected to the first connecting part, an extending part extending from the first busbar connecting part to the second connecting part, and a second busbar connecting part bent from the extending part and connected to the second connecting part; and
a busbar holder with electrical insulation that covers the extending parts of the plurality of busbars arranged in such a way as to separate the second busbar connecting parts from each other, and
the cover includes:
an opening closing part that closes the opening; and
a partition wall with electrical insulation that projects from the opening closing part toward the plurality of second connecting parts to which the second busbar connecting parts are connected and that is inserted between the second busbar connecting parts adjacent to each other.

2. The mechanical-electrical integrated rotary electric machine device according to claim 1, wherein
the busbar holder integrally covers the plurality of extending parts arranged to be separated from each other.

3. The mechanical-electrical integrated rotary electric machine device according to claim 2, wherein
the plurality of busbars are formed of plate-shaped conductors,
the plurality of extending parts are placed side by side, with a gap formed between extending parts, in a direction perpendicular to a direction of penetrating the plate-shaped conductors from their front surfaces to back surfaces, and
the busbar holder includes: a first holder member with electrical insulation that covers a front surface side of the plurality of extending parts; and a second holder member with electrical insulation that covers a back surface side of the plurality of extending parts.

4. The mechanical-electrical integrated rotary electric machine device according to claim 3, wherein
a first partition the first holder member has and a second partition the second holder member has are arranged in the gap,
counter surfaces of the first partition and the second partition have a convex part and a concave part, respectively, and
the convex part of the first partition is fitted into the concave part of the second partition, and the convex part of the second partition is fitted into the concave part of the first partition.

5. The mechanical-electrical integrated rotary electric machine device according to claim 1, wherein
the cover is made of an electrically insulating material.

6. The mechanical-electrical integrated rotary electric machine device according to claim 5, wherein
a metal plate is embedded in the opening closing part of the cover.

7. The mechanical-electrical integrated rotary electric machine device according to claim 3, wherein
the second busbar connecting part is bent from the extending part such that one of front and back surfaces of the second busbar connecting part is counter to the opening, and
the second connecting part is placed in such a way as to be counter to one of the front and back surfaces of the second busbar connecting part.
